(19) United States
(12) Patent Application Publication
(10) Pub. No.: US 2018/0334384 A1
(43) Pub. Date: Nov. 22, 2018

(54) SYSTEMS, REACTORS, METHODS AND COMPOSITIONS FOR PRODUCING CHLORINE DIOXIDE

(71) Applicant: ChemE Solutions Process Engineering Inc., Lake Stevens, WA (US)

(72) Inventors: Geoffrey Lawrence STENSLAND, Lake Stevens, WA (US); David Robert RAVANDER, Longview, WA (US)

(21) Appl. No.: 15/777,770

(22) PCT Filed: Nov. 22, 2016
(86) PCT No.: PCT/US16/63383

§ 371 Date: May 21, 2018

Related U.S. Application Data
(60) Provisional application No. 62/260,051, filed on Nov. 25, 2015.

(51) Int. Cl. C01B 11/02; C01B 7/07; B01D 19/00

(52) U.S. Cl. CPC C01B 11/026; B01D 19/0036; C01B 7/0743

(57) ABSTRACT

Systems and methods for producing chlorine dioxide in a single vessel process include a simplified control of sodium sulfate concentration, particularly for small to medium scale chlorine dioxide generators. The benefits of the described systems and methods include high chlorate efficiency, compact design and low sulfuric acid use. In some embodiments, the described systems and methods produce chlorine dioxide and separate the chlorine dioxide for use in the treatment of drinking water. The separated chlorine dioxide for use in the treatment of drinking water has no chlorate of chlorite or levels of chlorate or chlorite that are well below allowed limits. Novel compositions from which to produce chlorine dioxide include mixtures of hydrogen peroxide and a miner al acid and mixtures of an alkali metal chlorate, alkali metal salt and hydrogen peroxide are also described.

### BACKGROUND

### Technical Field

The embodiments described herein relate to systems and methods for the production of chlorine dioxide, including systems and methods for producing chlorine dioxide that utilize chlorates salts and peroxide. The embodiments described herein also relate to mixtures of chemicals useful in systems and methods for producing chlorine dioxide.

### Description of the Related Art

Producing chlorine dioxide from sodium chlorate requires the removal of the reaction by-product, sodium sulfate, from the process. For larger scale chlorine dioxide generators, e.g., such as chlorine dioxide generators of the scale found in pulp and paper mills, the sodium sulfate is typically removed by mechanical filtering and is not generally viewed as a problem. In contrast, in smaller scale production of chlorine dioxide, removing sodium sulfate and controlling sodium sulfate concentration is more challenging.

U.S. Pat. No. 5,380,517 describes that hydrogen peroxide can be used as the reducing agent in the production of chlorine dioxide according to the following formula:

NaClO₃+½H₂SO₄+½H₂O₂→ClO₂+H₂O+½O₂+½Na₂SO₄

Handling sodium sulfate produced in the generation of chlorine dioxide is a continuous challenge. In large industrial chlorine dioxide generation systems, sodium sulfate is allowed to build up in the reaction vessel to the salting out point of the sodium sulfate. The salted out sodium sulfate is then removed from the reactor vessel, isolated and stored or disposed of, often on a batch or continuous basis. While isolating the sodium sulfate in this manner is a common practice in larger scale industrial size operations, it is not acceptable for a smaller scale chlorine dioxide generation due to the complexity of the separation processes. There is a need for an effective way to manage the buildup of sodium sulfate produced during the generation of chlorine dioxide, especially in smaller scale generation, where separation processes used for larger scale chlorine dioxide generation are not attractive.

There are processes for producing chlorine dioxide on a small scale (U.S. Pat. No. 6,790,427) that can be characterized as a two chemical process where a highly concentrated mineral acid is used and creates needed heat and acidity when mixed with sodium chlorate and peroxide. These methods of chlorine dioxide generation utilize large amounts of excess acid per unit of chlorine dioxide produced. In some cases these large amount of excess acid require the use of expensive chemicals to raise the pH back up to the where the treated process needs to run (e.g., air scrubbers). It is not unusual to spend 10 to 15% more on neutralization chemicals (per pound of chlorine dioxide produced) with processes that utilize large amounts of excess acid. The excess acid used in these types of processes is on the order of about four pounds per pound of chlorine dioxide produced.

### BRIEF SUMMARY

The approaches described herein may address some of the issues which have limited adoption of on-site chlorine dioxide generation on smaller scales. The approaches described herein provide effective ways to manage the buildup of sodium sulfate encountered during the production of chlorine dioxide from alkali metal chlorates and hydrogen peroxide. The approaches described herein also provide chemical compositions useful as feedstocks for processes for producing chlorine dioxide.

For example, subject matter described herein relates to processes for producing chlorine dioxide that include steps of feeding a mixture of hydrogen peroxide and a mineral acid to a reactor including a reaction vessel and a gas-liquid separator and feeding an alkali metal chlorate to the reactor. In the reactor, chlorate ions are reduced to form chlorine dioxide and the salt of the mineral acid fed to the reactor. The reaction mixture in the reactor also includes chlorine dioxide and the salt of the mineral acid resulting from the reduction of chlorate ions, at least a portion of the mixture of hydrogen peroxide and mineral acid fed to the reactor and at least a portion of the alkali metal chlorate fed to the reactor. The process further includes the steps of withdrawing chlorine dioxide from the gas-liquid separator and a portion of the reaction mixture from the gas-liquid separator.

In some aspects of embodiments described herein, processes for producing chlorine dioxide include a step of concentrating the reaction mixture by removing water from the reaction mixture. Such concentrating results in an increase in the concentration of components within the reaction mixture, e.g. mineral acid and alkali metal salt of the mineral acid.

In accordance with other aspects of embodiments described herein, processes for increasing the concentration of a salt of a mineral acid in a reaction mixture produced by a process for producing chlorine dioxide include feeding a mixture of hydrogen peroxide and the mineral acid to a reactor including a reaction vessel and a gas-liquid separator. Alkali metal chlorate is also fed to the reactor and the chlorate ions are reduced to form chlorine dioxide and the salt of the mineral acid fed to the reactor. The reaction mixture in the reactor includes chlorine dioxide and the salt of the mineral acid resulting from the reduction of chlorate ions, at least a portion of the mixture of hydrogen peroxide and mineral acid fed to the reactor and at least a portion of the alkali metal chlorate fed to the reactor. In the gas-liquid separator, the concentration of the mineral acid and the salt of the mineral acid in the reaction mixture is increased by evaporating water from the reaction mixture.

In accordance with yet other aspects, processes for managing concentration of a salt of a mineral acid in a reaction mixture produced by a process for producing chlorine dioxide include feeding a mixture of hydrogen peroxide and the mineral acid to a reactor including a reaction vessel and a gas-liquid separator and feeding an alkali metal chlorate to the reactor. Chlorate ions are reduced to form chlorine dioxide in the reactor and the salt of the mineral acid fed to the reactor. A reaction mixture in the reactor includes chlorine dioxide and the salt of the mineral acid resulting from the reduction of chlorate ions, at least a portion of the mixture of hydrogen peroxide and mineral acid fed to the reactor and at least a portion of the alkali metal chlorate fed to the reactor. The concentration of the salt of the mineral acid in the reaction mixture contained in the gas-liquid separator is increased by causing the temperature of the reaction mixture in the gas-liquid separator to be between 100° F. to 180° F. and causing the pressure within the gas-liquid separator to be below 760 mmHg. These processes further include a step of withdrawing a portion of the reaction mixture from the gas-liquid separator.

In some aspects, the concentration of the salt of the mineral acid in the reaction mixture in the gas-liquid separator includes removing water from the reaction mixture in the gas-liquid separator.

Exemplary aspects of compositions for use in the production of chlorine dioxide in accordance with subject matter described herein include 10 to 96 weight percent mineral acid, 2 to 15 weight percent hydrogen peroxide and water.

In other exemplary aspects of compositions for use in the production of chlorine dioxide in accordance with subject matter described herein include 30 to 50 weight % alkali metal chlorate, 1 to 3 weight % alkali metal sulfate, 4 to 12 weight % hydrogen peroxide and water.

In another exemplary aspect of a process for managing the concentration of a salt of a mineral acid in a reaction mixture produced during the production of producing chlorine dioxide, the process includes feeding a mixture of hydrogen peroxide and the mineral acid to a reaction vessel; feeding an alkali metal chlorate to the reaction vessel; in the reaction vessel, reducing chlorate ions to form chlorine dioxide and the salt of the mineral acid fed to the reaction vessel, the reaction mixture in the reaction vessel including chlorine dioxide and the salt of the mineral acid resulting from the reduction of chlorate ions, at least a portion of the mixture of hydrogen peroxide and mineral acid fed to the reaction vessel and at least a portion of the alkali metal chlorate fed to the reaction vessel; causing the temperature of the reaction mixture in the reaction vessel to be between 100° F. to 180° F.; causing the pressure within the reaction vessel to be below 760 mmHg; and withdrawing a portion of the reaction mixture from the reaction vessel.

In other exemplary embodiments, a portion of the mixture of hydrogen peroxide and a mineral acid fed to the reaction vessel and a portion of the alkali metal chlorate fed to the reaction vessel are circulated through the reaction vessel using a thermal siphon.

### BRIEF DESCRIPTION OF THE SEVERAL VIEWS OF THE DRAWINGS

In the drawings, identical reference numbers identify similar elements unless otherwise indicated. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and they have been solely selected for ease of recognition in the drawings.

FIG. 1 is a schematic illustration of a piping and instrumentation diagram of a chlorine dioxide reactor according to a non-limiting embodiment of the subject matter described herein.

FIG. 2 is a schematic illustration of a piping and instrumentation diagram of a chlorine dioxide reactor according to another non-limiting embodiment of the subject matter described herein.

FIG. 3 is a schematic illustration of a piping and instrumentation diagram of a chlorine dioxide reactor according to another non-limiting embodiment of the subject matter described herein.

FIG. 4 is a graph showing mineral acid used per pound of chlorine dioxide produced in accordance with embodiments for producing chlorine dioxide according to subject matter described herein.

FIG. 5 is a table showing chlorate efficiency vs. temperature vs. vacuum conditions for conversion of sodium chlorate to chlorine dioxide produced in accordance with embodiments of subject matter described herein.

FIG. 6 is a schematic illustration of a piping and instrumentation diagram of a chlorine dioxide reactor according to another non-limiting embodiment of the subject matter described herein.

FIG. 7 is a schematic illustration of a piping and instrumentation diagram of a chlorine dioxide reactor according to another non-limiting embodiment of the subject matter described herein.

### DETAILED DESCRIPTION

It will be appreciated that, although specific embodiments of the present disclosure are described herein for purposes of illustration, various modifications may be made without departing from the spirit and scope of the present disclosure. Accordingly, the present disclosure is not limited except as by the appended claims.

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with reactors for producing chlorine dioxide from sodium chlorate, sulfuric acid and hydrogen peroxide have not been shown or described in detail to avoid unnecessarily obscuring descriptions of the embodiments.

Unless the context requires otherwise, throughout the specification and claims that follow, the word “comprise” and variations thereof, such as “comprises” and “comprising” are to be construed in an open, inclusive sense, that is, as “including, but not limited to.”

Reference throughout the specification to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same aspect. Furthermore, the particular features, structures, or characteristics may be combined in any suitable manner in one or more aspects of the present disclosure.

The use of ordinals such as first, second and third does not necessarily imply a ranked sense of order, but rather may only distinguish between multiple instances of an act or structure.

In the figures, identical reference numbers identify similar features or elements. The sizes and relative positions of the features in the figures are not necessarily drawn to scale.

As used herein, the term reactor refers to a combination of one or more of a reactor vessel, a gas-liquid separator, reactor circulation pump, piping, heater, eductor and instrumentation to maintain desired process conditions.

A one or two chemical process for smaller scale onsite generation of chlorine dioxide from alkali metal chlorate would be attractive. In accordance with embodiments described herein hydrogen peroxide and mineral acid are combined to form a single mixture that can be delivered to a site where chlorine dioxide will be generated using an alkali metal chlorate. The blend of mineral acid and hydrogen peroxide is stable and enables the production of chlorine dioxide by feeding two products (e.g., blend of mineral acid and hydrogen peroxide and alkali metal chlorate) to the chlorine dioxide generation system. Feeding two chemicals, as opposed to more than two chemicals, reduces both chemical handling and chemical storage costs. In another embodiment, chlorine dioxide is generated from alkali metal chlorate and peroxide without the need to store a mineral acid at the site where chlorine dioxide will be generated. In the latter embodiments, a mixture of alkali metal chlorate, hydrogen peroxide and an alkali metal salt is used as the feedstock in the generation of chlorine dioxide.

In accordance with aspects of embodiments for producing chlorine dioxide described herein, the removal of alkali metal sulfate, e.g., sodium sulfate, produced during the production of chlorine dioxide is achieved continuously and effectively by controlling the temperature, pressure and liquid level in a separation vessel, thereby establishing a controlled evaporation rate of liquids from the separation vessel. Because the chemicals used to generate chlorine dioxide contain a significant amount of water, this water needs to be evaporated and removed. By controlling the amount of evaporation, in accordance with aspects of embodiments described herein, purge of alkali metal sulfate from the separation vessel is managed and controlled, often without the need for complicated level sensors, which can introduce a level of complication, expense and uncertainty into the removal of the alkali metal sulfate.

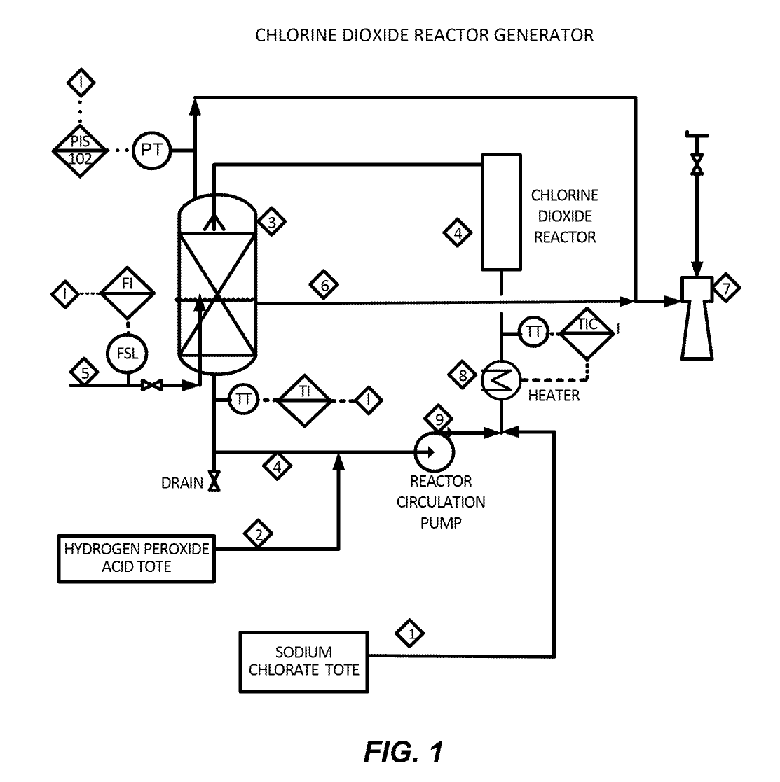

Referring to FIG. 1, a system and method for producing chlorine dioxide from sodium chlorate, hydrogen peroxide and sulfuric acid is illustrated and described. It should be understood that while the embodiment of FIG. 1 and other embodiments described herein are with reference to sodium chlorate and sulfuric acid, sodium chlorate is an example of alkali metal chlorates useful in embodiments described herein and sulfuric acid is an example of mineral acids useful in accordance with embodiments described herein. The present disclosure is not limited to sodium chlorate and/or sulfuric acid. The processes of the present disclosure can be practiced using alkali metal chlorates, other than sodium chlorate, and mineral acids, other than sulfuric acid.

The system illustrated in FIG. 1 includes a sodium chlorate source 1, hydrogen peroxide and sulfuric acid mixture source 2, reactor circulation pump 9, heater 8, reaction vessel 4, gas-liquid separator 3, and eductor 7. Hydrogen peroxide and sulfuric acid 2 as a mixture are fed to the suction side of reactor circulation pump 9. Sodium chlorate is fed to the discharge side of the pump 1. The sodium chlorate, hydrogen peroxide and sulfuric acid mixture is then delivered to heater 8 where the temperature of the mixture is elevated. From heater 8, the mixture is delivered to reaction vessel 4. It should be understood that some reaction and formation of chlorine dioxide may occur in heater 8 as well as in the line between heater 8 and reaction vessel 4 as well as in other lines or vessels of the system. After passing through reaction vessel 4, the reaction products (chlorine dioxide, water, oxygen and sodium sulfate) and unreacted hydrogen peroxide (if any), sodium chlorate, and sulfuric acid are received in separator 3, where they are separated into liquid and vapor components. Pressure in separator 3 is below the pressure of reaction vessel 4, so liquid from reaction vessel 4 is flashed into separator 3 via a nozzle or other dispersion device. Chlorine dioxide and water vapor within the headspace of separator 3 is drawn to eductor 7 where the vapor is mixed with water and sent to subsequent processes that utilize chlorine dioxide. The vapor in separator 3 will include chlorine dioxide, water vapor, oxygen and nitrogen (from diluent air). Diluent air may be added to separator 3 via line 5. Adding air to separator 3 via line 5 helps to maintain a low partial pressure of chlorine dioxide in separator 3. Maintaining a low partial pressure of chlorine dioxide in separator 3 is desirable because at partial pressures above about 150 mm Hg, chlorine dioxide may decompose to chlorine gas and oxygen. The liquid fraction in separator 3 can be overflowed by gravity via line 6 to eductor 7. In this manner a portion of the contents of the liquid fraction in separator 3 (including sodium sulfate) are removed from the system. In the embodiment illustrated in FIG. 1, gaseous chlorine dioxide and water vapor drawn from the headspace of separator 3 are combined with gaseous chlorine dioxide and water vapor contained in the liquid phase removed from gas-liquid separator 3 via line 6. This combined stream is removed from the system and is ready for use in subsequent processes or can be subjected to further processing to isolate components from each other.

It should be understood that although FIG. 1 illustrates providing hydrogen peroxide and sulfuric acid as a mixture, the present embodiment is not so limited. The hydrogen peroxide and sulfuric acid can be provided as separate chemicals instead of a mixture of the two. In addition, the sodium chlorate from source 1 can be supplied at a location downstream of heater 8, e.g., between heater 8 and reaction vessel 4.

It is also contemplated that water be added to purge line 6 in FIGS. 1-3 in order to reduce the likelihood the sodium sulfate in purge line 6 will salt out within purge line 6.

In accordance with one aspect of embodiments described herein for producing chlorine dioxide, the concentration of sodium sulfate in the liquid phase within separator 3 ranges between 5 and 60 weight % sodium sulfate, 5 and 50 weight %, 5 and 40 weight % or 5 and 30 weight % (weight %=weight of solute divided by weight of solution). It should be understood that these ranges of sodium sulfate concentration are exemplary and that the concentration of sodium sulfate in the liquid phase of separator 3 can be any value provided it is less than the weight % at which sodium sulfate would precipitate from the liquid phase in separator 3. When the sodium sulfate concentration in separator 3 is maintained at these levels, systems and process in accordance with embodiments described herein for producing chlorine dioxide can be run continuously without the need to stop the process and remove sodium sulfate.

For a desired production rate of chlorine dioxide, in an exemplary embodiment, reaction vessel 4 is filled with a mixture of 50 weight % sulfuric acid and 7 weight % hydrogen peroxide and brought to desired operating conditions. The temperature of the contents of reaction vessel 4 are maintained in the range between 100 and 180 degrees F. or a range between 120 to 160 degrees F. A temperature sensor may be located in the recirculation stream near the exit of heater 8 to control the operation of heater 8 so as to maintain the temperature of the reactants in reaction vessel 4 at the desired temperature. Heater 8 should be able to withstand the environment of reaction vessel 4, and may be made from materials such as glass, quartz, carbon, and tantalum. The vacuum setting of the reactor is established between 15 and 28 inches of Hg vacuum or between 19 and 23 inches Hg vacuum. Vacuum is established by running water through eductor 7 to create a vacuum in reaction vessel 4 of approximately 28 inches Hg vacuum. The vacuum may be lowered by opening an air rotometer to establish air flow into the reactor to reduce the vacuum to 19 to 23 inches Hg and dilute the chlorine dioxide gas and maintain its partial pressure below pressures where chlorine dioxide may decompose. An exemplary range for the flow of dilution air is between 6 and 10 L/min for a production rate of 100 pounds per day chlorine dioxide.

By establishing a desired temperature and pressure within the reactor, e.g., gas-liquid separator 3, the rate of evaporation of water from the reaction mixture can be adjusted. For example, the water content of the reaction mixture in the gas-liquid separator 3 can be maintained at 30 to 65 weight % or between 40 and 50 weight % which corresponds to a boiling point for the reaction mixture at the prescribed temperature and pressure. The sulfuric acid strength in the reaction mixture is controlled at a concentrated level between 4 and 15 N, 7 and 14 N or between 9 and 11 N by continuously evaporating water from the reaction mixture.

In an exemplary embodiment the sodium chlorate solution that is mixed with the hydrogen peroxide and sulfuric acid is a 40 weight % solution, although more concentrated or less concentrated sodium chlorate solutions may be used depending on the temperature and pressure of the reactor and the concentration of the sulfuric acid and water. The sodium chlorate reacts with sulfuric acid and hydrogen peroxide to produce chlorine dioxide, sodium sulfate, oxygen and water. The desired reactor conditions are controlled so that over 95% of the sodium chlorate feed is converted to chlorine dioxide in less than 60 seconds. It should be understood that the embodiments described herein are not limited to processes that convert over 95% of the sodium chlorate feed to chlorine dioxide in less than 60 seconds. For example, embodiments described herein can convert less than 95% of the sodium chlorate feed to chlorine dioxide and take less or more than 60 seconds to do so.

In an exemplary embodiment, the sulfuric acid/hydrogen peroxide blend that is fed to reactor is a 50 weight % sulfuric acid/7 weight % hydrogen peroxide solution and is continuously added to the reactor solution to replenish sulfuric acid converted to sodium sulfate, hydrogen peroxide converted to water and acid and hydrogen peroxide lost to the purge stream via line 6. A small purge stream 6 through a side nozzle in separator 3 provides continuous withdrawal of liquid containing sodium sulfate and other chemicals to maintain the sodium sulfate concentration below the level where it will precipitate out of solution (salting) and potentially plug piping.

The rate of purge at operating conditions is established by the feed rate of the sulfuric acid/hydrogen peroxide solution and the concentration of the sulfuric acid and hydrogen peroxide in the solution. For example, an exemplary feed ratio of 50 weight % sulfuric acid/7 weight % hydrogen peroxide solution to 40 weight % sodium chlorate solution ranges from about 0.9:1 to 1.2:1 or about 1:1 by volume. These exemplary feed ratios result in sodium sulfate levels between 20 and 35 weight % and more preferably between 25 and 30 weight %.

The system is operated at a pressure that is in part determined by the desired production rate. Operating pressures are chosen to be in a range that allows the system to be built using relatively inexpensive materials of construction such as chlorinated plastics, including chlorinated polyvinyl chloride (CPVC), and reinforced fiberglass lined with chlorinated plastic. Suitable pressures include moderate to high-vacuum conditions that range between 19 to 25 inches Hg vacuum. Such vacuum conditions can be achieved utilizing eductor 7 and water. Utilizing water in eductor 7 has the added advantage that the water can also be used as dilution for the chlorine dioxide. Dilution of chlorine dioxide is often required in order to transport the chlorine dioxide to its point of use. The vacuum can be adjusted by allowing air to be bled into separation chamber 3. There may be advantages to setting up different generators to run at different pressures and temperatures. The vacuum is set by the characteristics of eductor 7 and the amount and pressure of water passed through eductor 7. Because the water volume is set there could be a need to generate a higher or lower chlorine dioxide concentration in the water for distribution to the process. Each generation rate has a desired evaporation rate for maintaining the desired efficiency. The parameters that provided the desired evaporation rate can be set up in the field and this process could be automated if desired. For example, the flow rate and pressure of water supplied to eductor 7 may be set specifically for a specific chlorine dioxide reactor. By keeping the flow rate and pressure of water supplied to eductor 7 unchanged while adjusting the flow of sodium chlorate and sulfuric acid up or down, the rate of chlorine dioxide production can be varied. For example, a reactor sized to produce 100 lb/day chlorine dioxide solution will produce approximately 9 gpm of solution containing 1,000 ppm chlorine dioxide. To reduce chlorine dioxide production by half, the sulfuric acid and chlorate solution feed rates can be lowered by half to produce approximately 9 gpm of solution containing 500 ppm chlorine dioxide.

Chlorine dioxide can decompose to chlorine gas and oxygen when chlorine dioxides partial pressure exceeds about 150 mm Hg, provided other conditions such as temperature, pressure, etc., are conducive to chlorine dioxide decomposition. Evaporation of water from the system and the amount of air introduced via line 5 play an important role in avoiding decomposition of the chlorine dioxide to chlorine gas and oxygen. When the rate and amount of water evaporation in separator 3 can fluctuate in ways that could result in the partial pressure of chlorine dioxide in separator 3 rising above 150 mm Hg, the addition of air into separator 3 via line 5 can help to maintain the partial pressure of chlorine dioxide below 150 mm Hg. Air that is introduced via line 5 is introduced into separator 3 near the top of the liquid phase in separator 3 where it can help strip chlorine dioxide out of the water. Though not illustrated, separator 3 includes plastic, hollow, spherical packing comprised of chlorinated polyvinylchloride or other plastic material capable of withstanding the chemical and physical conditions within separator 3 without deteriorating. Factors that should be taken into account when selecting a specific packing design include high contact or transfer efficiency, low pressure drop, and good chemical resistance to chemicals found in separator 3.

Packing is used to facilitate separation of the gas containing chlorine dioxide, water vapor, and oxygen from the liquid containing water, sulfuric acid and sodium sulfate. Packing is used to provide high surface area to allow disengagement of dissolved gases from the reactor liquid. The dilution air also provides a motive source to assist in stripping dissolved gases from the liquid.

Control of the water evaporation rate for a desired chlorine dioxide production rate also allows the system to control the purge rate of liquid and gas from separator 3. As illustrated in FIG. 1, separator 3 includes a port in fluid communication with purge line 6 which extends between separator 3 and eductor 7. In accordance with embodiments described herein, purging separator 3 helps to control and prevent the buildup of sulfate salts within the system, especially separator 3. It has been observed that sulfate salts that build up in the range of between 5 to 30 weight % can be controlled by controlling the level of the liquid phase in separator 3. The purge port in separator 3 is located at a predetermined location and is in fluid communication with purge line 6. As reaction products chlorine dioxide, water, oxygen and sodium sulfate and unreacted hydrogen peroxide, sodium chlorate and sulfuric acid and excess water associated with the hydrogen peroxide, sodium chlorate and sulfuric acid flow from reaction vessel 4 to separator 3, the liquid level in separator 3 will rise at some % faster than the rate of evaporation of liquid within separator 3. When the excess water added to the reactor with the chemicals (acid, peroxide and chlorate) increases the volume of liquid in separator 3 at x ml per hour, the rate at which the level of liquid within separator 3 changes can be controlled by controlling the rate of liquid evaporation within separator 3. (When the reactor is being operated at the desired pressure and temperature levels, the ratio of chlorate feed to sulfuric acid feed to purge rate to vapor gas product is approximately 1 lb to 1 lb to 1 lb to 1 lb plus dilution air of approximately 0.1 lb.)

For example, when the excess water added to the reactor with the chemicals (acid, peroxide and chlorate) increases the volume of liquid in separator 3 at x ml per hour, the level of liquid within separator 3 can be maintained steady be controlling the evaporation rate at a functional rate of approximately x ml per hour minus the rate of purge P from separator 3. In this manner, the evaporation rate of liquid can be used to control the purge rate based on energy input to the reactor recycle loop. (Evaporation rate of water is established by the temperature and vacuum conditions in the reactor. If the temperature drops lower at a fixed vacuum condition, the evaporation rate will be reduced. If the vacuum is increased at fixed temperature, the evaporation rate will increase. Heat is added to the reactor by heater 8 to maintain a fixed temperature and the eductor and dilution air are used to establish a fixed vacuum. The use of eductor 7 and heater 8 are examples of devices that can be used to adjust pressure and temperature within the system; however, other devices can be used to adjust the pressure and temperature of the system.) A benefit of the evaporation is that the efficiency of acid use is improved due to the concentrating of acid as the water vapor is released. In U.S. Pat. No. 6,790,427, the need to keep excess acid (high normality) in the chlorine dioxide generator throughout the reaction is necessary to keep the chlorate conversion efficiency at desirable levels. In the process described in U.S. Pat. No. 6,790,427, a drop in normality of 2 in the reactor would result in the efficiency of chlorate conversion dropping quickly to levels which would make the process of U.S. Pat. No. 6,790,427 undesirable, and likely useless from a commercial standpoint. As a result, the excess acid utilized in the process of the '427 patent is about 4 parts excess acid to one part chlorine dioxide produced. In contrast, in accordance with embodiments described herein, acid normality is maintained in the system, including reaction vessel 4 and separator 3 as water is evaporated. Accordingly, in accordance with aspects of some embodiments described herein, chlorate conversion efficiency in excess of 90%, 95% and even 99% can be achieved with excess acid levels of about 1 part acid to one part chlorine dioxide produced. Another effect of the evaporation of water from the reaction mixture in gas-liquid separator 3 is that it increases the concentration of the salt of the mineral acid in the reaction mixture contained in the separator.

The reaction rate should be maintained at a high level so most of the alkali metal chlorate is reacted and excess chlorate is not lost to the purge. The normality of reaction vessel 4 is intentionally maintained between 8 to 16, and more preferably between 10 to 14. Within these normality ranges and residence times of between 5 and 180 seconds conversion of the chlorate fed to reaction vessel 4 is nearly complete (conversion of chlorate to chlorine dioxide) and the reactor efficiency approaches 99% efficiency. For example, when operating within the above normality ranges, the concentration of alkali metal chlorate in the purge can be maintained at less than 2% and preferably less than 0.5%. At these concentration levels, nearly all the chlorate is converted to chlorine dioxide.

As an example of one of the benefits of embodiments described herein when used in a continuous flow reactor, if sodium chlorate, hydrogen peroxide and sulfuric acid were heated to 150 degrees F. and the reactor contents were overflowed so as to act as a once through reactor, the efficiency of chlorate utilization would only be a fraction of that achieved if embodiments of the present invention are used, because the normality would not be sufficient, even at elevated temperature to produce chlorine dioxide efficiently. This is one reason why a once through reactor such as described in the '427 patent uses a large amount of excess acid when using sodium chlorate as a reactant. In processes and systems for producing chlorine dioxide in accordance with embodiments described herein, elevated normality is controlled and maintained by evaporating some of the water in the recirculation loop that flows through separator 3 and reaction vessel 4. Thus, high levels of chlorate conversion can be achieved using much less acid.

In another example of advantages of embodiments described herein, utilizing a large reactor with level control and raising the temperature of the acid, without concentrating the acid through evaporation, the acid normality would fall as water would accumulate in the separator and reactor (from the addition water associated with the sodium chlorate, hydrogen peroxide and sulfuric acid). To combat this drop in acid normality, higher chlorate levels can be used to maintain reactor performance. Doing so would lead to a loss of chlorate efficiency as compared to processes in accordance with embodiments described herein, as the higher concentration of chlorate would be lost through purging of liquid from separator 3.

In accordance with aspects of embodiments described herein and still referring to FIG. 1, the temperature and pressure are set for reaction vessel 4 to provide a given production rate of chlorine dioxide. Both the sulfuric acid-hydrogen peroxide blend and the liquid sodium chlorate are fed to reactor vessel 4 as described above. The liquid level control aspect of embodiments described herein provides a distinct advantage over conventional instrumentation, as such conventional instrumentation used for liquid level control in the environment of modest sulfuric acid can be difficult to use and does not offer the simplicity and reliability in operation of a fixed volume reactor used in presently described embodiments. In accordance with the embodiment illustrated in FIG. 1, as the concentration of sulfate salts in separator 3 increases, the rate of evaporation in separator 3 decreases (due to increasing boiling point of the liquid solution in separator 3). This will result in the liquid level in separator 3 rising above the port in fluid communication with purge line 6 and liquid being purged from separator 3. The purged liquid will contain sodium sulfate, water, sulfuric acid and low levels of sodium chlorate and peroxide. The system comes to an equilibrium state for feed rates, evaporation and/or gas generation, and purge rates. The flow balance for the purge amount is the difference between the two feed streams and water evaporation rate from the reactor solution. This equilibrium conditions can be changed by changing chemical feed rates, temperature or pressure. Increasing the sulfuric acid feed relative to chlorate feed will increase the sulfuric acid concentration in solution and lower sodium sulfate concentration. Increasing temperature will increase water evaporation and result in a higher concentration of sulfuric acid and sodium sulfate in the reactor solution. Lowering the vacuum will decrease the water evaporation rate and result in lower concentrations of sulfuric acid and sodium sulfate.

In another aspect of embodiments described herein, foaming in the recirculation line can be controlled. Controlling the chlorate concentration below 1 weight % in separator 3 reduces and/or eliminates foaming that was previously observed to occur in the recirculation line when chlorate concentration levels were higher. If the reaction of chlorate continues in separator 3 and/or the recirculation line between separator 3 and reaction vessel 4 (due to high chlorate levels) oxygen is liberated by the reaction and becomes entrained in the liquid which can lead to cavitation in reactor circulation pump 9. Cavitation in reactor circulation pump 9 can cause foaming of the liquid. Foaming is undesirable because it can lead to significant increases in purge and have a detrimental effect on the reactor circulation pump. It is desirable to add the chlorate feed after the reactor circulation pump to minimize potential to cavitate the circulation pump. Avoiding liberation of oxygen (which can lead to pump cavitation) above desired levels is also why chlorate is preferably fed to the discharge side (as opposed to the suction side) of reactor circulation pump 9.

Embodiments described herein are able to produce chlorine dioxide at acid normality levels that are closer to the stoichiometric level of acid. Accordingly, the excess acid can be as low as 1 pound per pound of chlorine dioxide produced or lower. This provides a significant cost savings over processes that must utilize much more excess acid and also require additional chemicals to neutralize the excess acid.

In another advantage of the embodiments described herein, it has been observed that hydrogen peroxide when blended with and mineral acid, e.g., sulfuric acid, in a ratio of between 10:1 (acid to peroxide) and 1:1, preferably in a ratio of 8:1 to 3:1 is a stable product that can be used in the processes and systems described herein, thus making the processes and systems described herein, essentially two chemical processes and systems. This discovery is beneficial in that the chemicals used are dilute; however, due to the operation of the process and system, the chemical efficiency exceeds the efficiency of many commercially available technologies. The cost savings of this approach is significant due to the lower acid use and high efficiency of the process. Exemplary blends of hydrogen peroxide and mineral acid include 2 to 15 weight % hydrogen peroxide and 10 to 96 weight % mineral acid, other exemplary blends of hydrogen peroxide and mineral acid include 2-13 weight % hydrogen peroxide and 15-65 weight % mineral acid.

### EXAMPLE 1

A mixture of hydrogen peroxide and sulfuric acid were blended in a 4:1 weight ratio. After 21 days the decomposition of the peroxide was less than 3%, allowing the product to still be efficiently used for in production of chlorine dioxide utilizing the processes and systems described herein. The decomposition after four weeks was still at levels that made the use of the mixture acceptable for the production of chlorine dioxide utilizing the processes and systems described herein.

### EXAMPLE 2

Details of test apparatus unit. A small chlorine dioxide reactor with a volume of 5 liters was filled with a blend of 40 weight % sulfuric acid and 10 weight % hydrogen peroxide. The reactor was heated to 140 degrees Fahrenheit at 22 inches Hg vacuum. A 40 weight %sodium chlorate solution and a blend of 50 weight % sulfuric acid and 7 weight % hydrogen peroxide were fed in equal parts to the reactor. Chlorine dioxide was produced at a chemical efficiency of 99%. A purge equal to 20% or less of the volume of chemical fed was maintained which maintained the concentration of sodium sulfate below saturation. The process was run continuously for 20 days.

Details of test apparatus. A reactor was fabricated consisting of a 5 liter reaction vessel, heater, vacuum eductor, circulation pump and piping, chemical feed apparatus for 40 weight % sodium chlorate and 50 weight % sulfuric acid/8 weight % hydrogen peroxide solution, and eductor water feed pump as illustrated in FIG. 1. The reactor was charged with 2.5 L of 50 weight % sulfuric acid and recirculated using an inline centrifugal pump at flow rates of 5 to 15 gpm. The reactor solution was heated to between 140 and 160 degrees F. A thermocouple was used to turn on and off the heater to maintain temperature in the reactor.

City water was fed to an eductor feed pump and connected to the eductor to pull a vacuum. The eductor pump supplied 18.8 liters per minute water to the vacuum eductor at 120 psig and 60 degrees F. The charged eductor produced a vacuum of 28 inches Hg in the reactor. An air rotometer and tubing was connected to the reactor. The rotometer was adjusted to add 4 liters per hour ambient air to the reactor which lowered the reactor vacuum to 22 inches Hg.

The 40 weight % sodium chlorate was added continuously at 4.6 ml/min to the piping after the discharge of the circulation pump. A 50 weight % sulfuric acid/8 weight % hydrogen peroxide solution blend was added continuously at 4.1 ml/min to the reactor piping prior to the circulation pump. Samples were taken periodically from the reactor at approximate rate of 50 ml every hour.

The reactor was operated continuously over 20 days and performance data collected. The conversion of sodium chlorate to chlorine dioxide was observed at over 95% when sulfuric acid concentration was over 8.5 N at 150 degrees F. and over 96% when sulfuric acid concentration was over 9.5 N at 140 degrees F. Direct measurement of eductor volume and chlorine dioxide concentration in the eductor water further showed sodium chlorate conversion to chlorine dioxide to be over 95% at the same conditions. At sulfuric acid concentrations above 10 N and 145 degrees F., the conversion of sodium chlorate to chlorine dioxide was observed to be over 98%.

The sulfuric acid concentration ranged from 25 to 40% in the reactor over the course of the trial and the sodium sulfate concentration ranged between 20 and 32%. Salting of the sodium sulfate did not occur when the reactor was circulated and the temperature of the reactor was maintained at 140 degrees F.

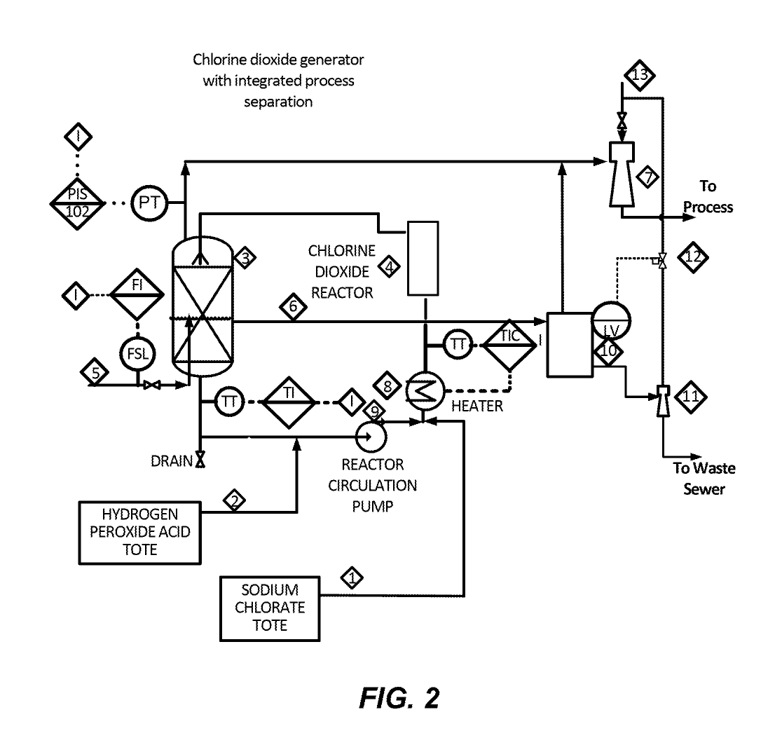

In another aspect, systems, processes and compositions described herein can be used to produce chlorate and chlorite free chlorine dioxide suitable for drinking water applications. In drinking water applications, chlorine dioxide has an important role as it performs excellent on many bacteria. However recently there are concerns about the health effects of some of the reactants used in producing chlorine dioxide on site. In another aspect of the embodiments described herein and illustrated in FIG. 2, purge from separator 3 which contains chlorine dioxide, water, low levels of chlorate, sodium sulfate and sulfuric acid are not discharged into the water line caring the chlorine dioxide to the process to be treated with the chlorine dioxide, but rather are separated and discharged to sewer (can be discharged in the same or separate line to sewer depending on end use dictates). The salts (e.g., sodium sulfate and unreacted sodium chlorate) are removed by gravity from separator 3 and collected in an overflow vessel 10 until a time when eductor 11 creates a vacuum (or another form of removal system) capable of removing the overflow vessels contents and delivering them to the sewer or other disposal option. It should be understood that although an eductor is illustrated and described as producing a vacuum, different devices for producing a vacuum can be used as well as removal systems that do not rely upon a vacuum to removed contents from the overflow vessel 10.

The process illustrated in FIG. 2 is identical to that illustrated FIG. 1, with the addition of an overflow vessel 10. Overflow vessel 10 is at the same pressure as separator 3, so purged liquid including sodium sulfate can be gravity drained to overflow vessel 10. When overflow vessel 10 is filled to a set point detected by a level sensor 13, water valve 12 is turned on. Turning on water valve 12 starts a vacuum which draws the purged salts from overflow vessel 10 and delivers it to a sewer or other disposal resource. Water valve is turned off once a low level is detected by level sensor 13.

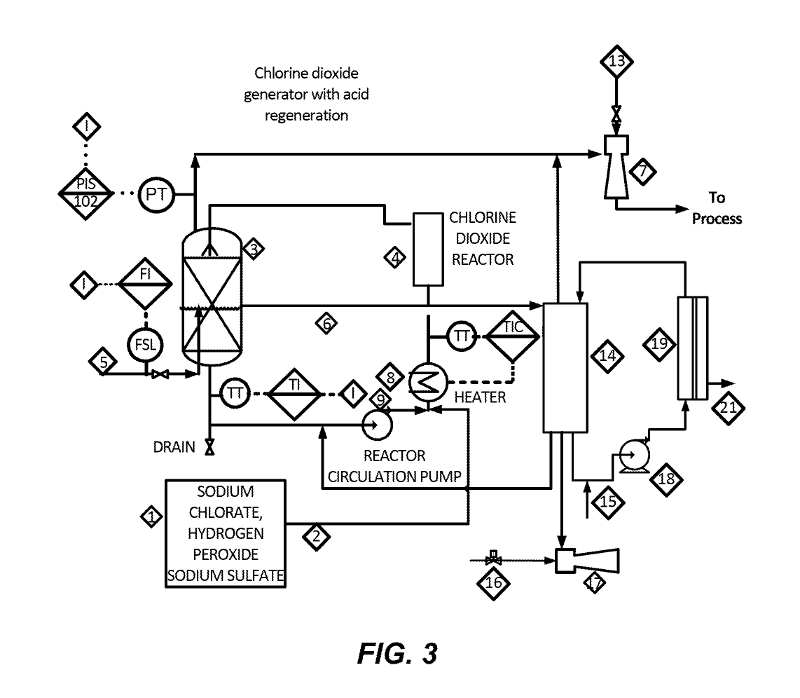

In another aspect illustrated in FIG. 3 below, an alternative system is illustrated which can lead to significant improvements in chemical handling and plant safety. Currently, many chlorine dioxide applications require a strong mineral acid for the onsite production of chlorine dioxide. In accordance with embodiments described herein and specifically illustrated in FIG. 3, an electrolyzer is used to treat the acid containing purge from separator 3 that is collected in overflow vessel 14 in FIG. 3. Thus, in this embodiment, the purged acid containing stream normally sent to waste is instead diverted to an acid regeneration system in the form of an electrolyzer. In certain instances water may be added to the purge being sent to electrolyzer at 15. This regeneration system electrolytically removes sodium and produces sulfuric acid from sulfate which can be returned to overflow vessel 14 in FIG. 3. This regenerated sulfuric acid can then be used as feed to the chlorine dioxide reactor by delivering it from overflow vessel 14 to the suction side of reactor circulation pump 9 via line 2 in FIG. 3. It should be understood that although the embodiment of FIG. 3 is illustrated and described with reference to an electrolyzer for producing sulfuric acid from the separator purge, the present description is not limited to the use of an electrolyzer. Other devices, e.g., electrodialysis devices could be used in place of an electrolyzer to produce sulfuric acid from the separator purge. In this embodiment, because sulfuric acid is generated on site it is not necessary to deliver and store sulfuric acid on site. The feed chemistry for use in embodiments in accordance with this aspect of the present disclosure includes a mixture of sodium chlorate, hydrogen peroxide and sodium sulfate.

The process illustrated in FIG. 3 is identical to the process illustrated in FIG. 2 with one difference. In FIG. 3, the purged separator contents resident in overflow vessel 14 in FIG. 3 are diluted with water at 15 and sent to an electrolyzer 11 in FIG. 3 to produce sulfuric acid from sodium sulfate and displace the sodium building up in the separator 3.

In FIG. 3, there is still a small purge from the separator 3 that needs to occur due to Impurities (e.g., chloride ion) build up in the system. This purge comes from a timed purge using eductor (17) which is in fluid communication with overflow vessel 14 in FIG. 3. Eductor 17 is supplied with water via source 16. A modified feed chemistry is used with this embodiment. Instead of sulfuric acid, the feed chemistry includes sodium sulfate. Sodium sulfate is needed to maintain the sulfate concentration in the reaction loop to maintain the electrolyzer efficiency for converting sodium sulfate to sulfuric acid. In accordance with this embodiment, the sodium chlorate, hydrogen peroxide and sodium sulfate can be delivered to and stored at the chlorine dioxide production site as a single mixture. Exemplary embodiments of mixtures containing alkali metal chlorate, hydrogen peroxide and alkali metal sulfate include 30 to 50 weight % or 35 to 45 weight % or 40 weight % alkali metal chlorate, 6 to 12% weight % hydrogen peroxide and 1 to 5% weight percent alkali metal sulfate.

In some installations, anhydrous or “dry” sulfuric acid is available on site for use in the generation of chlorine dioxide. In those instances where concentrated sulfuric acid at 93 weight % is available for use in the generation of chlorine dioxide, the benefit would be approximately 50% less energy input required to maintain the same acid efficiency as using 50 weight % acid solution due to less total amount of water to evaporate. However, the process would then be a three chemical process and not have the advantage of the two chemical sulfuric acid/hydrogen peroxide blend.

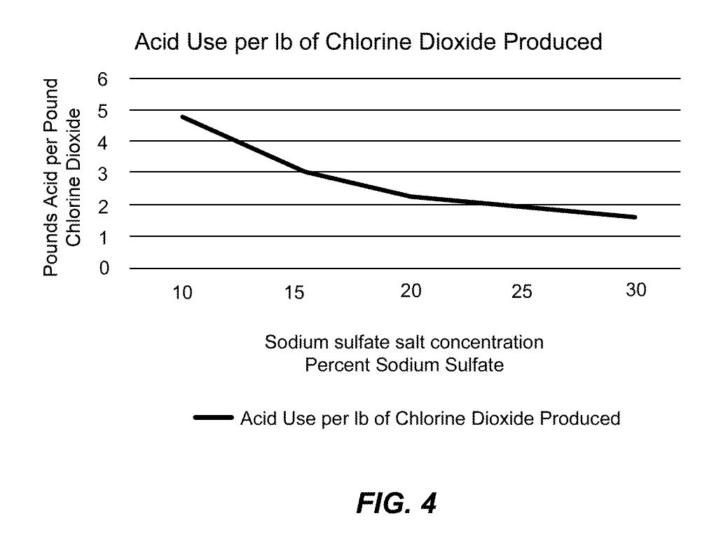

FIG. 4 represents data collected from Example 2. FIG. 4 shows the acid used per pound of chlorine dioxide produced in Example 2.

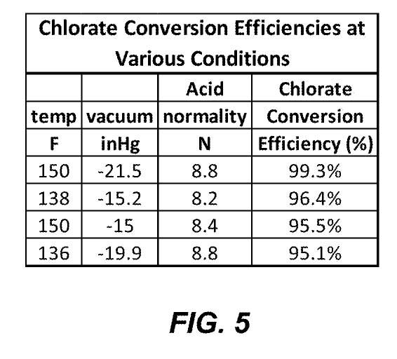

FIG. 5 represents data showing efficiency vs temperature vs vacuum curve for conversion of sodium chlorate to chlorine dioxide in accordance with embodiments described herein.

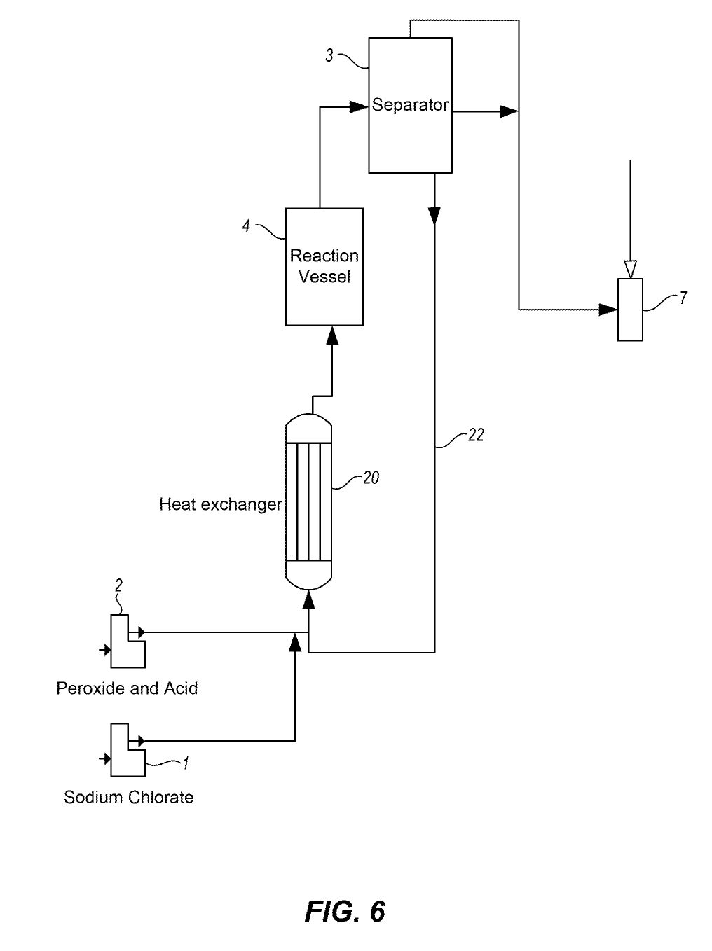

Referring to FIG. 6, the process illustrated and described with reference to FIG. 6 is identical to the process illustrated and described with reference to FIG. 1 with the exception that instead of using recirculation pump 9 to cause liquid to flow through reaction vessel 4 and to gas-liquid separator 3, a thermal siphon is used to cause liquid to flow through reaction vessel 4 and to gas-liquid separator 3. The description with reference to FIG. 1 of sodium chlorate source 1, hydrogen peroxide and sulfuric acid mixture source 2, reaction vessel 4, gas- liquid separator 3 and eductor 7 is applicable to the sodium chlorate source 1, hydrogen peroxide and sulfuric acid mixture source 2, reaction vessel 4, gas-liquid separator 3, and eductor 7 utilized in embodiments in accordance with FIG. 6. The thermal siphon utilized in FIG. 6 is represented by a heat exchanger 20 and a circulation line 22. In operation, a reaction mixture is removed from reactor vessel 4 and delivered to separator 3. Liquids separated in separator 3 and delivered via circulation line 22 to the inlet of heat exchanger 20. The temperature of the reaction mixture is decreased as it passes through heat exchanger 20 prior to being reintroduced to reaction vessel 4. The thermal gradient between the hotter reaction mixture removed from separator 3 and the cooler reaction mixture introduced to reaction vessel 4 provides a natural convection that causes the reaction mixture to circulate through reaction vessel 4, separator 3 and heat exchanger 20 without the need for a mechanical pump or with reduced reliance on a mechanical pump. It should be understood that this thermal siphon can also be used in the processes illustrated and described with reference to FIGS. 2 and 3 as a replacement for reactor circulation pump 9.

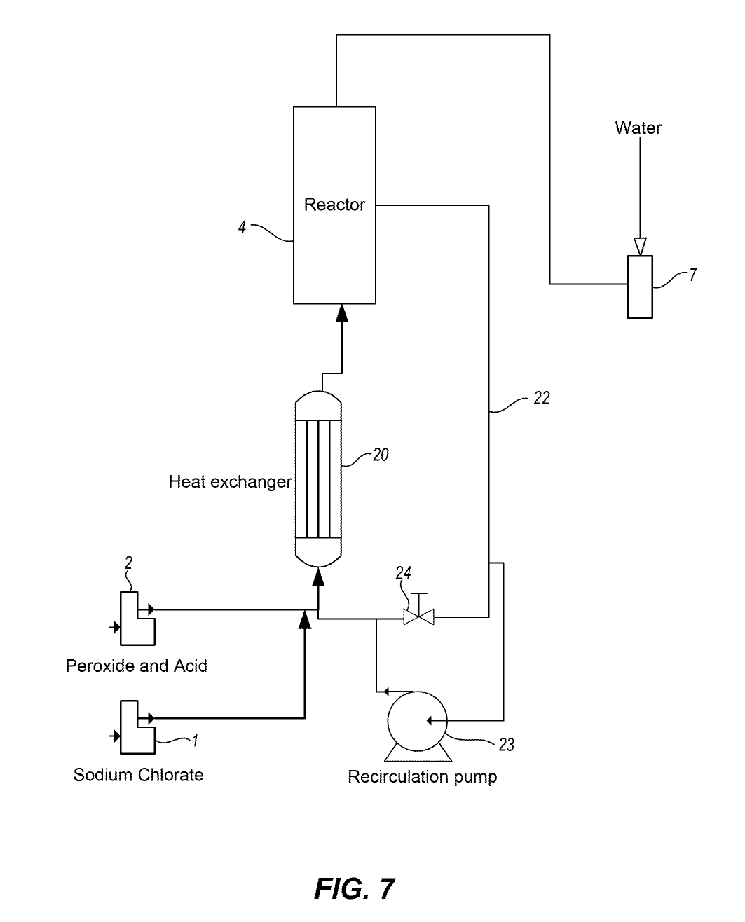

Referring to FIG. 7, the process ans system illustrated and described with reference to FIG. 7 is identical to the process and system illustrated and described with reference to. FIG. 6, with the exception that gas-liquid separator 3 is omitted. In embodiments in accordance with FIG. 7, The description with reference to FIG. 6 of sodium chlorate source 1, hydrogen peroxide and sulfuric acid mixture source 2, reaction vessel 4 and eductor 7 is applicable to the sodium chlorate source 1, hydrogen peroxide and sulfuric acid mixture source 2, reaction vessel 4 and eductor 7 utilized in embodiments in accordance with FIG. 7. The thermal siphon utilized in FIG. 7 is represented by a heat exchanger 20 and a circulation line 22. In operation, a reaction mixture is removed from reactor vessel 4 and circulated to an inlet of heat exchanger 20 via circulation line 22. The temperature of the reaction mixture is decreased as it passes through heat exchanger 20 prior to being reintroduced to reaction vessel 4. The thermal gradient between the hotter reaction mixture removed from reaction vessel 4 and the cooler reaction mixture introduced to reaction vessel 4 provides a natural convection that causes the reaction mixture to circulate through reaction vessel 4 and heat exchanger 20 without the need for a mechanical pump or with reduced reliance on a mechanical pump 23 illustrated in FIG. 7. The system illustrated in FIG. 7 includes a valve 24 which can be used to balance the reliance upon a thermal siphon and mechanical pump 23 for purposes of moving the reaction mixture through reaction vessel 4 and heat exchanger 20. In the system of FIG. 7, the composition and normality of the reaction mixture can be controlled by temperature and pressure while having only gas discharge from the top of reaction vessel 4. In accordance with embodiments described with reference to FIG. 7, introduction of fresh sodium chlorate, hydrogen peroxide and sulfuric acid can occur either before or after heat exchanger 20; with introduction before heat exchanger 20 being preferred.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A process for producing chlorine dioxide comprising:
feeding an alkali metal chlorate, hydrogen peroxide and a mineral acid to a reaction vessel, the mineral acid having a normality between 7 and 14;
in the reaction vessel, reducing chlorate ions to form chlorine dioxide and a salt of the mineral acid fed to the reaction vessel,
providing to a gas-liquid separator from the reaction vessel, a reaction mixture including chlorine dioxide, the salt of the mineral acid resulting from the reduction of the chlorate ions, at least a portion of the alkali metal chlorate, hydrogen peroxide and mineral acid fed to the reaction vessel;
withdrawing chlorine dioxide gas from the gas-liquid separator;
withdrawing a liquid portion of the reaction mixture from the gas-liquid separator, the liquid portion of the reaction mixture withdrawn from the gas-liquid separator containing less than 2 weight % chlorate; and
returning the liquid portion of the liquid reaction mixture withdrawn from the gas-liquid separator to the reaction vessel.

2. The process of claim 1, further comprising concentrating the reaction mixture by removing water from the reaction mixture in the gas-liquid separator.

3-4. (canceled)

5. A process for managing the concentration of a salt of a mineral acid in a reaction mixture produced during the production of chlorine dioxide, the process comprising:
feeding an alkali metal chlorate, hydrogen peroxide and a mineral acid to a reaction vessel, the mineral acid having a normality between 1 and 14;
in the reaction vessel, reducing chlorate ions to form chlorine dioxide and a salt of the mineral acid fed to the reaction vessel;
providing to a gas-liquid separator from the reaction vessel, a reaction mixture including chlorine dioxide, the salt of the mineral acid resulting from the reduction of chlorate ions, at least a portion of the alkali metal chlorate, hydrogen peroxide and mineral acid fed to the reaction vessel;
causing the temperature of the reaction mixture in the gas-liquid separator to be between 100° F. to 180° F.;
causing the pressure within the gas-liquid separator to be below 760 mmHg; and
withdrawing a liquid portion of the reaction mixture from the gas-liquid separator, the liquid portion of the reaction mixture withdrawn from the gas-liquid separator containing less than 2 weight % alkali metal chlorate; and
withdrawing chlorine gas from the gas-liquid separator.

6-7. (canceled)

8. The process of claim 1, further comprising introducing a diluent gas into the gas-liquid separator.

9. (canceled)

10. The process of claim 5, further comprising returning at least a portion of the liquid portion of the reaction mixture withdrawn from the gas-liquid separator to the reaction vessel.

11-12. (canceled)

13. The process of claim 1, wherein the mineral acid is 93 weight % sulfuric acid.

14. The process of claim 1, wherein the liquid portion of the reaction mixture withdrawn from the gas-liquid separator contains less than 1 weight % alkali metal chlorate.

15. The process of claim 1, further comprising maintaining a partial pressure of the chlorine dioxide in the gas-liquid separator below 150 mm Hg.

16. The process of claim 1, further comprising maintaining the pressure in the reaction vessel within the range of 15-28 inches Hg vacuum.

17. The process of claim 1, wherein the reaction mixture provided to the gas-liquid separator from the reaction vessel is a liquid reaction mixture.

18. The process of claim 5, wherein the mineral acid is 93 weight % sulfuric acid.

19. The process of claim 5, wherein the liquid portion of the reaction mixture withdrawn from the gas-liquid separator contains less than 1 weight % alkali metal chlorate.

20. The process of claim 5, further comprising maintaining a partial pressure of the chlorine dioxide in the gas-liquid separator below 150 mm Hg.

21. The process of claim 5, further comprising maintaining the pressure in the reaction vessel within the range of 15-28 inches Hg vacuum.

22. The process of claim 5, wherein the reaction mixture provided to the gas-liquid separator from the reaction vessel is a liquid reaction mixture.
